(19) United States
(12) Patent Application Publication
(10) Pub. No.: US 2020/0273118 A1
(43) Pub. Date: Aug. 27, 2020

(54) Production Surveillance - Management System

(71) Applicant: ExxonMobil Upstream Research Company, Spring, TX (US)

(72) Inventors: Dimitri J. Papageorgiou, Stewartsville, NJ (US); Myun-Seok Cheon, Whitehouse Station, NJ (US); Stijn De Waele, Flemington, NJ (US); Amr El-Bakry, Houston, TX (US); James B. McGehee, Spring, TX (US); Thomas M. Snow, Houston, TX (US); Ashutosh Tewari, Clinton, TX (US)

(21) Appl. No.: 16/718,763

(22) Filed: Dec. 18, 2019

Related U.S. Application Data
(60) Provisional application No. 62/809,069, filed on Feb. 22, 2019.

(51) Int. Cl. G06Q 50/02; G06N 7/00; E21B 47/00; E21B 41/00; E21B 49/08; G06Q 10/06; G06Q 10/04

(52) U.S. Cl. CPC G06Q 50/02; G06N 7/005; E21B 47/00; E21B 43/34; E21B 49/087; G06Q 10/06316; G06Q 10/04; E21B 41/0092

(57) ABSTRACT

A method and apparatus for hydrocarbon management includes production surveillance and management, such as obtaining input for a plurality of wells in a field, wherein the input comprises well information collected for at least one of the wells in the field; creating a forecast based on the input; generating a well seriatum for the plurality of wells based on the input and the forecast; and monitoring an implementation of the well seriatum to obtain the input for the plurality of wells for a subsequent iteration of such methods. A method and apparatus includes, for a plurality of iterations, obtaining input for a plurality of wells, including well information collected for at least one well; creating a forecast based on the input; generating a well seriatum based on the input and the forecast; and monitoring an implementation of the well seriatum to obtain the input for a subsequent iteration.

### CROSS REFERENCE TO RELATED APPLICATIONS

This application claims the priority benefit of U.S. Provisional Patent Application No. 62/809,069, filed Feb. 22, 2019, entitled PRODUCTION SURVEILLANCE—MANAGEMENT SYSTEM.

### FIELD

This disclosure relates generally to the field of hydrocarbon recovery and/or reservoir management operations to enable production of subsurface hydrocarbons. Specifically, exemplary embodiments relate to methods and apparatus for monitoring, managing, initiating, and/or regulating production events (e.g., choking and/or shutting-in one or more wells) for a reservoir. Additionally, exemplary embodiments relate to methods and apparatus for determining a well seriatum (i.e., an ordered list of wells) for production, choke, and/or shut-in targets to optimize field-wide parameters.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

A petroleum reservoir is generally a subsurface pool of hydrocarbons contained in porous or fractured rock formations. Because a petroleum reservoir typically extends over a large area, possibly several hundred kilometers across, full exploitation entails multiple wells scattered across the area. In addition, there may be exploratory wells probing the edges, pipelines to transport the oil elsewhere, and support facilities. Reservoir structure may directly or indirectly connect fluid channels amongst the multiple wells, and reservoir structure may dictate potential flow rates in the various fluid channels.

At times, reservoir production constraints may implicate regulating production (e.g., shut in or choke one or more wells). The choice of which wells to regulate, to what extent, and over what time period may affect total oil and gas production and/or the profitability of the field.

Common current practice is to utilize a well seriatum that orders wells based on a metric associated with a single constraint. For example, when the constraint is a water-handling limit (e.g., produce no more than 2,000 gallons of water/day), the wells may be sorted according to water-cut (ratio of water to total production fluid). Those with the lowest water-cut may then be kept at full production, while those with the highest water-cut may be shut in. At times, the operator may select a number of wells to remain open according to the seriatum until the water-handling constraint is exceeded. As another example, the constraint may be a gas-handling limit. In this example, the wells may be sorted by gas-to-oil ratio (GOR), and those with the lowest GOR may be kept at full production, while those with the highest GOR may be shut in. At times, the operator may select wells to remain open according to the seriatum until the gas limit is exceeded. Current production regulation strategies may be heuristic, emphasizing practical implementation concerns over more rigorous strategies for production optimization.

According to current practice, production fluids are separated (e.g., by oil phase, water phase, and gas phase) as they are produced. Sensors (e.g., multiphase flow sensors) with limited accuracy are typically available at each well or, more often, a group of wells with commingled production. Moreover, each sensor typically only provides partial information (e.g. the total liquid rate, but not the rate per phase). Thus, accurate information about each phase at each well is typically not available. Production monitoring equipment that utilizes sensor fusion algorithms are available to obtain probabilistic estimates by combining the information from different sensors, observed at different times. However, even with sensor fusion, the resulting rates still carry a large uncertainty.

It would be beneficial to provide systems and methods for determining a well seriatum for production regulation targets, choke targets, and/or shut-in targets to optimize field-wide oil production and/or value subject to one or more production constraints using possibly noisy data and/or over a planning horizon of hours to months.

### BRIEF DESCRIPTION OF THE DRAWINGS

So that the manner in which the recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of scope, for the disclosure may admit to other equally effective embodiments and applications.

FIG. 1 illustrates a commingled well testing setup.

FIGS. 2A-D illustrate production monitoring for a group of four commingled wells.

FIG. 3 illustrates an example method of production surveillance and management.

FIG. 4 illustrates information from multiple production regulation events on a field of five wells.

FIGS. 5A-C illustrate an example implementation of the method of FIG. 3.

FIG. 6 illustrates another example implementation of the method of FIG. 3.

FIG. 7 illustrates another example implementation of the method of FIG. 3.

FIG. 8 further illustrates the example implementation of FIG. 7.

FIGS. 9A-D illustrate another example implementation of the method of FIG. 3.

FIGS. 10A-D further illustrate the example implementation of FIGS. 9A-D.

FIGS. 11A-B illustrate another example implementation of the method of FIG. 3.

FIGS. 12A-B illustrate another example implementation of the method of FIG. 3.

FIG. 13 illustrates a block diagram of a production data analysis system upon which the aforementioned methods and implementations may be embodied.

### DETAILED DESCRIPTION

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the content clearly dictates otherwise. Furthermore, the words “can” and “may” are used throughout this application in a permissive sense (i.e., having the potential to, being able to), not in a mandatory sense (i.e., must). The term “include,” and derivations thereof, mean “including, but not limited to.” The term “coupled” means directly or indirectly connected. The word “exemplary” is used herein to mean “serving as an example, instance, or illustration.” Any aspect described herein as “exemplary” is not necessarily to be construed as preferred or advantageous over other aspects. The term “uniform” means substantially equal for each sub-element, within about ±10% variation. The term “nominal” means as planned or designed in the absence of variables such as wind, waves, currents, or other unplanned phenomena. “Nominal” may be implied as commonly used in the field of hydrocarbon management.

The term “simultaneous” does not necessarily mean that two or more events occur at precisely the same time or over exactly the same time period. Rather, as used herein, “simultaneous” means that the two or more events occur near in time or during overlapping time periods. For example, the two or more events may be separated by a short time interval that is small compared to the duration of the overall operation. As another example, the two or more events may occur during time periods that overlap by about 40% to about 100% of either period.

As used herein, “hydrocarbon management” or “managing hydrocarbons” includes any one or more of the following: hydrocarbon extraction; hydrocarbon production, (e.g., drilling a well and prospecting for, and/or producing, hydrocarbons using the well; and/or, causing a well to be drilled to prospect for hydrocarbons); hydrocarbon exploration; identifying potential hydrocarbon-bearing formations; characterizing hydrocarbon-bearing formations; identifying well locations; determining well injection rates; determining well extraction rates; identifying reservoir connectivity; acquiring, disposing of, and/or abandoning hydrocarbon resources; reviewing prior hydrocarbon management decisions; and any other hydrocarbon-related acts or activities. The aforementioned broadly include not only the acts themselves (e.g., extraction, production, drilling a well, etc.), but also or instead the direction and/or causation of such acts (e.g., causing hydrocarbons to be extracted, causing hydrocarbons to be produced, causing a well to be drilled, causing the prospecting of hydrocarbons, etc.).

As used herein, “obtaining” data generally refers to any method or combination of methods of acquiring, collecting, or accessing data, including, for example, directly measuring or sensing a physical property, receiving transmitted data, selecting data from a group of physical sensors, identifying data in a data record, and retrieving data from one or more data libraries. In some embodiments, data may be collected by raw data acquisition. In some embodiments, models may be utilized to generate synthetic initial data (e.g., computer simulation). In some embodiments, the initial data may be obtained from a library of data from previous data acquisition or previous computer simulations. In some embodiments, a combination of any two or more of these methods may be utilized to generate the initial data.

If there is any conflict in the usages of a word or term in this specification and one or more patent or other documents that may be incorporated herein by reference, the definitions that are consistent with this specification should be adopted for the purposes of understanding this disclosure.

Embodiments disclosed herein provide systems and methods for systematic regulation of production events (e.g., well choking and/or shut-in operations). For example, a prioritization may be determined based on one or more field-wide production constraints, including facilities constraints (e.g. water-handling limitations, gas-handling limitations, total liquid limitations, power utilization limits, etc.) and/or reservoir conditions. For example, reservoir conditions may include coning or cusping, where high producing rates may result in the production of aquifer water or gas-cap gas through an inclined geological zone and into the production well. In some embodiments, information (e.g., historical data of individual wells and groups of wells, production forecasts for individual wells or groups of wells, and uncertainty in well production distribution) may be utilized in a decision-support framework. In some embodiments, time-based production, choke, and/or shut-in targets may be developed. For example, a seriatum of wells to shut in and/or choke may be developed for the planning horizon of interest. In some embodiments, the order of such actions may minimize oil loss, minimize expected production costs, maximize overall production, maximize expected production value, and/or maximize knowledge about asset state.

One of the many potential advantages of the embodiments of the present disclosure is that decisions and/or actions may be based on multiple constraints. Another potential advantage includes improved optimization, even when only one constraint is considered. Another potential advantage includes accounting for post-shut-in production. Another potential advantage includes systematically accounting for uncertainty and risk. Another potential advantage includes taking into account the benefits of updating rate estimates with data from monitoring implementations of past decisions, and using the updated estimates to make subsequent decisions. Another potential advantage includes using the sequential nature of the underlying decisions to improve the seriatum. Another potential advantage includes integration of production regulation decisions for each well. Another potential advantage includes providing a proactive strategy, especially when the constraint is removed. Embodiments of the present disclosure can thereby be useful in the discovery and/or extraction of hydrocarbons from subsurface formations.

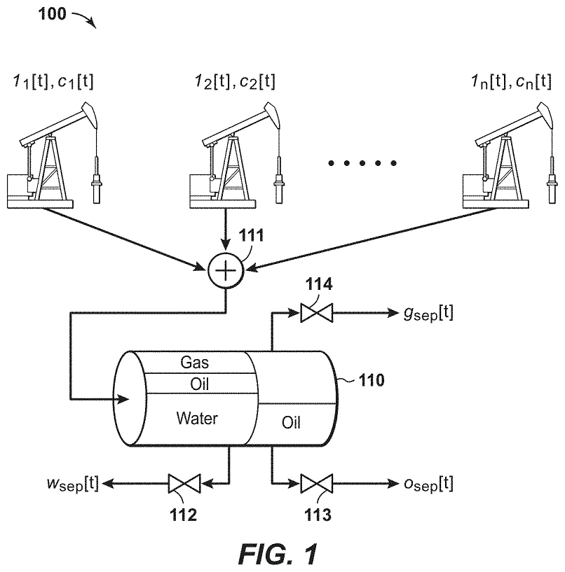

FIG. 1 illustrates a typical commingled well testing setup 100. For example, production rates for oil, water, and/or gas may be tested with setup 100. As illustrated, the production from n wells are commingled at manifold 111 to contribute to the collection/separation equipment 110. For any i^{th} well (out of n wells), the net liquid rate lᵢ[t] and the water-cut cᵢ[t] (percentage of water in the produced liquid) may be individually measured at the well. In some commingled well setups, such as offshore, it may be difficult or impossible to make measurements at the well. The aggregate separated water wₛₑₚ[t] may be measured at valve 112, the aggregate separated oil oₛₑₚ[t] may be measured at valve 113, and the aggregate separated gas gₛₑₚ[t] may be measured at valve 114. In some commingled well setups, manifold 111 may include a diverter/separator assembly (not shown). At times, production from a particular well, such as well j, may be routed to the diverter/separator assembly for measurement (e.g., water, oil, and/or gas measurement specific to well j). At other times, production from another particular well, such as well k, may be routed to the diverter/separator assembly for measurement (e.g., water, oil, and/or gas measurement specific to well k). In some commingled well setups, production from each well may be routed to such diverter/separator assembly for specified periods (e.g., 24 hours) on a regular and repeating basis (e.g., once per month).

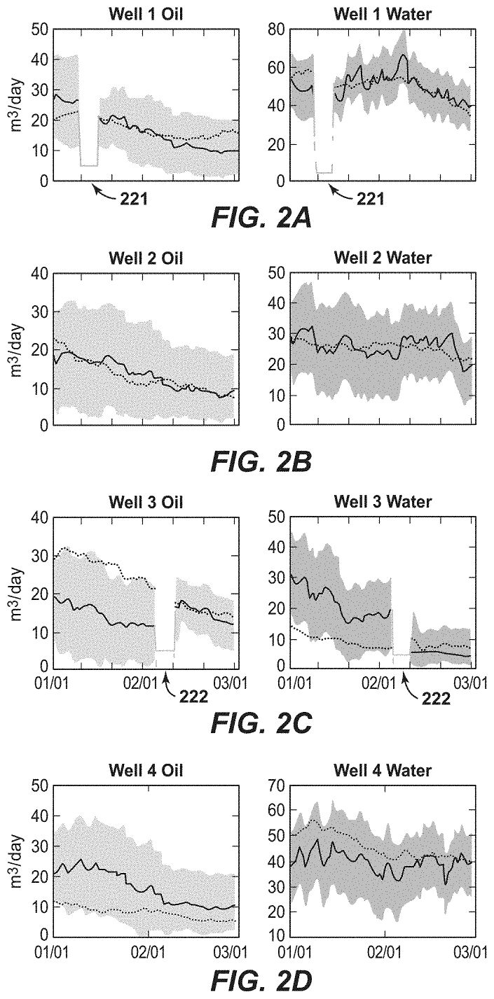

FIGS. 2A-D illustrate production monitoring for a group of four commingled wells in a simulated environment (similar to setup 100). The oil production rates (over time) are shown on the left graph of each figure, while the water production rates are shown on the right. In each figure, the dotted lines show the actual production rates (the dotted lines on the left show the actual oil production, and the dotted lines on the right show the actual water production). The solid lines denote the estimated production rates. The shadings indicate the estimated probability bands (spanning 5% to 95% uncertainty). Typically, the estimated probability bands are large due to the commingling of wells during well-tests.

FIGS. 2A and 2C illustrate shut-in events at time intervals 221 and 222, respectively. Note that the width of the probability bands in each graph of FIG. 2A is relatively narrow following time interval 221. Likewise, the width of the probability bands in each graph of FIG. 2C is relatively narrow following time interval 222. In this way, monitoring and analyzing a shut-in event may help resolve some of the uncertainty of commingled well production and/or improve the accuracy of the probability estimates.

Methods described herein may exploit information gained from the production regulation process. For example, wells may be shut in or choked to satisfy field-wide resource constraints. However, as discussed above, aggregate rate estimates may have a large uncertainty associated with them. Because the total oil production of a group of wells is typically measured, production regulation of one well in a group of wells (while monitoring the aggregate oil production before, during, and after the production regulation) may provide improved estimates of the regulated well's production. The improved estimates may then be utilized in subsequent time periods.

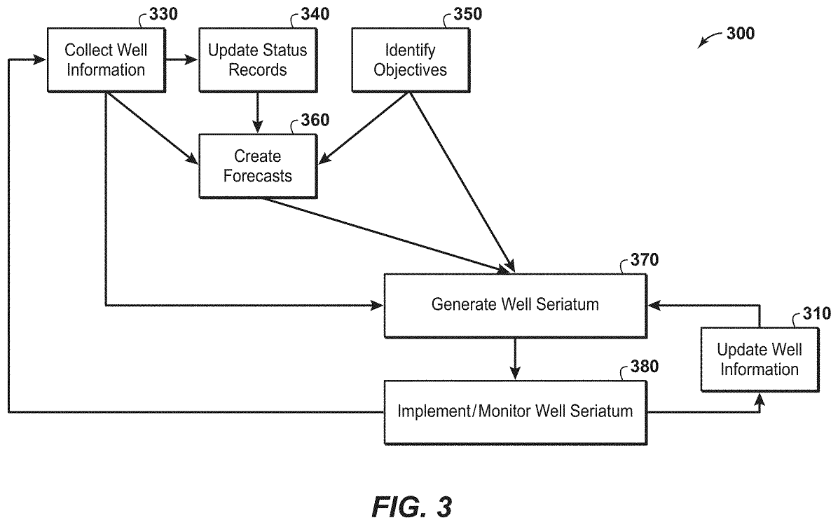

FIG. 3 illustrates an example method 300 of production surveillance and management. Method 300 obtains input at blocks 330, 340, and 350, each of which may occur at times concurrently, sequentially, and/or synchronized to the other inputs. At times, obtaining input at any one of blocks 330, 340, and 350 may occur independently of the other inputs.

At block 330, method 300 obtains input by collecting well information. For example, information from one or more wells in a field may be collected. The information may be collected automatically (e.g., over certain time intervals, such as hours, days, or weeks), manually (e.g., at the request of a user), and/or ad hoc (e.g., in response to a system trigger). The well information may include, for example, total production rate, oil production rate, water-cut, GOR, information over a time period, instantaneous information, fluid samples, seismic response, electromagnetic response, single well information, multi-well information, and/or field-wide information. The well information may be used as input to other portions of method 300, such as updating status records at block 340, creating forecasts at block 360, and/or generating well seriatum at block 370.

At block 340, method 300 obtains input by updating status records. The status records may be updated automatically (e.g., over certain time intervals, such as 1-24 hours, 1-7 days, or 1-4 weeks), manually (e.g., at the request of a user), and/or ad hoc (e.g., in response to a system trigger). The status records may include, for example, current production rate estimates, current commodity (e.g., oil or gas) pricing, equipment status (e.g., outages, multi-well manifold configuration, etc.), and resource limits (e.g., water-handling limits, gas-handling limits, power limits, pump-down facility capacity, etc.). The well information from block 330 may be used as input to updating status records at block 340, such as current production rate and/or indicating equipment outages. The status records may be used as input to other portions of method 300, such as creating forecasts at block 360 and/or generating well seriatum at block 370.

At block 350, method 300 obtains input by identifying objectives. The objectives may be identified automatically (e.g., over certain time intervals, such as hours, days, or weeks), manually (e.g., at the request of a user), and/or ad hoc (e.g., in response to a system trigger). The objectives may include, for example, maximizing oil production, maximizing gas production, minimizing water production, minimizing power consumption, minimize oil loss, maximize oil uplift, maximizing knowledge about field performance, maximizing well group diversification, and/or other user-set criterion or criteria. At times, the objectives may be time-based. For example, an objective may be to maximize oil production during summer months and maximize gas production during winter months. The identified objectives may be used as input to other portions of method 300, such as creating forecasts at block 360 and/or generating well seriatum at block 370.

At times, method 300 may continue at block 360 where forecasts are created. For example, forecasts may be created for future production (for one or more wells in the field), future resource limits, future power outages/limitations, and/or future crude/gas prices. The well information from block 330, the status records from block 340, and/or the objectives from block 350 may be used as input to creating forecasts at block 340. In some embodiments, creating forecasts may utilize models, such as mechanistic or data-driven (statistical) models. In some embodiments, the models may include representations of reservoir porosity, connectivity, and/or fluid communication.

Method 300 may continue at block 370 where a well seriatum is generated. For example, the well seriatum may identify production regulation events (e.g., shut-in and choke management) for one or more wells in the field. The production regulation events may be time-based. The well information from block 330, the status records from block 340, the objectives from block 350, and/or the forecasts at block 340 may be used as input to generating the well seriatum at block 370. For example, a well seriatum may be generated at block 370 in accordance to user-specified set of objectives from block 350. The well seriatum may include overlapping and/or simultaneous production regulation events for multiple wells. In some embodiments, field equipment may include manifolds that facilitate multi-well production regulation. It should be understood that the updated status records from block 340 may include multi-well manifold configurations, which may influence the generated well seriatum.

Method 300 may continue at block 380 where the well seriatum from block 370, or a derivative thereof, may be implemented and/or monitored. For example, an operator may implement some, none, or all of the actions identified in the well seriatum. In some embodiments, the actions may be implemented in a sequential manner. For example, an operator may sequentially shut in one or more wells if confronted with restrictive resource limits, and/or sequentially open (e.g., bring online) one or more wells if resource limits are no longer present. In some embodiments, monitoring the well seriatum at block 380 may result in generating an updated well seriatum at block 370. For example, the well seriatum may be updated based on asset response to previous decision(s). In some embodiments, monitoring at block 380 may provide a quality-control check of the implementing at block 380 (confirming the asset performed as expected) and/or of the well seriatum generated at block 370 (confirming the field responded as expected).

Method 300 continues with a feedback loop from implementing/monitoring the well seriatum at block 380 to collecting well information at block 330. As illustrated in FIGS. 2A-D, monitoring response to production regulating events may improve the accuracy of well production estimates and also help resolve some of the uncertainty therein due to well commingling. In particular, monitoring (at block 380) the wells during the illustrated shut in at time interval 221 (in FIG. 2A) may collect information (at block 330) that creates an updated forecast (at block 360) of production rate estimates. In some embodiments, portions or all of method 300 may be repeated multiple times, for example, to provide more robust information about a field.

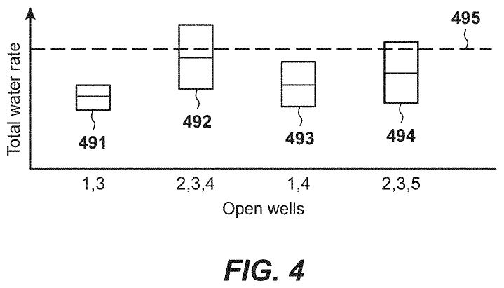

Information gathered from one or more portions of method 300 may be assembled, analyzed, and/or displayed. For example, FIG. 4 illustrates information from multiple production regulation events on a field of five wells. Column 491 illustrates total water production for wells 1 and 3 (wells 2, 4, and 5 being shut in). Column 492 illustrates total water production for wells 2, 3, and 4 (wells 1 and 5 being shut in). Column 493 illustrates total water production for wells 1 and 4 (wells 2, 3, and 5 being shut in). Column 494 illustrates total water production for wells 2, 3, and 5 (wells 1 and 4 being shut in). The horizontal line in each column indicates the mean water rate, while the shaded box indicates the probability estimate (e.g., the bottom edge of each shaded box indicates the 25^{th} percentile, while the top edge of each shaded box indicates the 7^{th} percentile). The dotted line 495 indicates the water-handling limit. As illustrated, column 494 indicates a slight possibility that wells 2, 3, and 5 will exceed the water-handling limit, while column 492 indicates a greater likelihood that wells 2, 3, and 4 will exceed the water-handling limit.

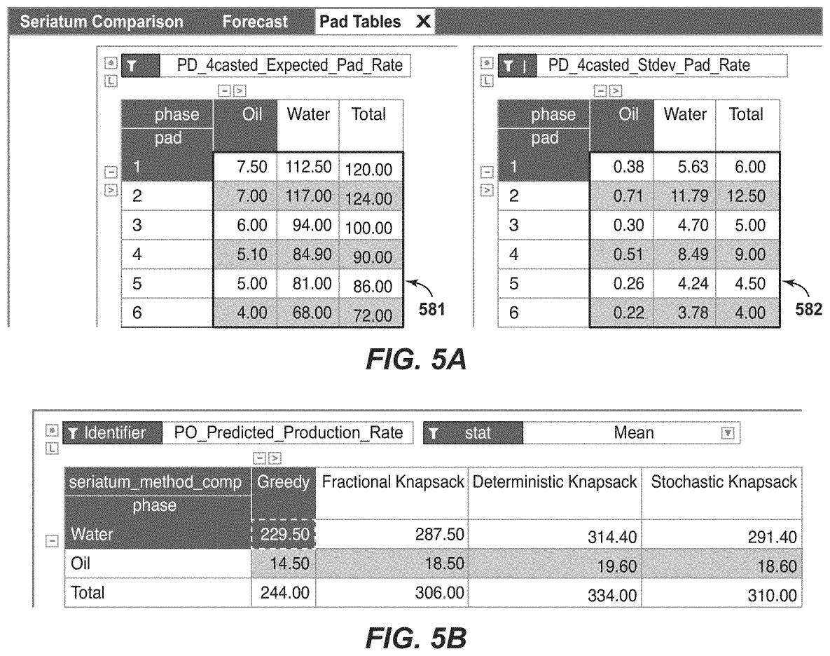

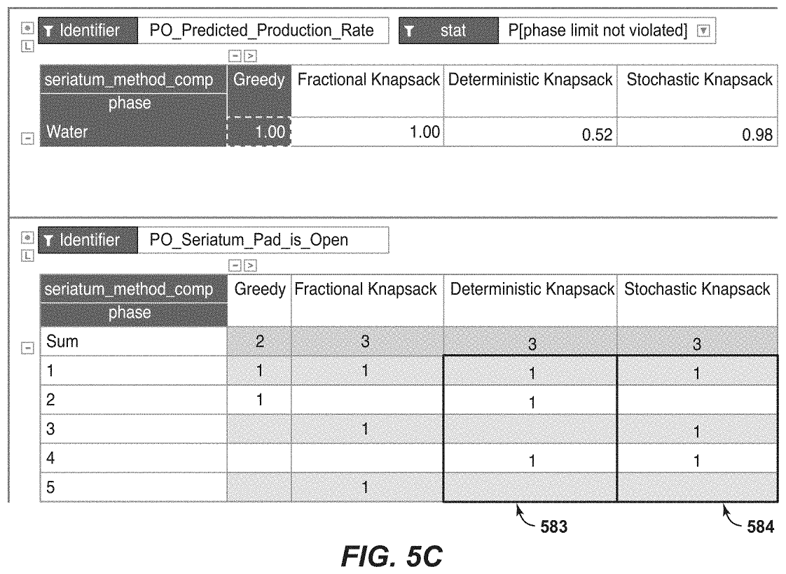

A first example implementation of method 300 is illustrated in FIGS. 5A-C. In this first example, the only production constraint is a water-handling rate limit of 315 kilo barrels per day (kbd). This example illustrates a field of six pads, where each pad consists of a single well. As a point of reference, assuming all pads are producing, total expected liquid production is 592 kbd and total expected water production is 557.4 kbd. FIG. 5A shows the expected oil, water, and total production rates for each pad (at 581), and the standard deviation thereof (at 582). FIG. 5B illustrates predicted oil and water production rates for four different proposed seriatum strategies: Greedy, Fractional Knapsack, Deterministic Knapsack, and Stochastic Knapsack. Notably, the Greedy strategy sorts the pads in non-increasing order according to expected oil production, and then selects (to keep open) the pads in this order until the total expected water production exceeds the water-handling limit. The Fractional Knapsack solution sorts the wells in increasing order according to water-cut, and then selects (to keep open) pads in this order until the water-handling limit is exceeded. Both the Greedy and the Fractional Knapsack strategies may be characterized as heuristic solutions. The Deterministic Knapsack method formulates the problem as a deterministic knapsack problem with side constraints. For example, a fractional knapsack problem, possibly with side constraints, may be represented as follows:

$$\begin{matrix}{max}_{y ∈ ℱ} 𝔼 [ {\sum }_{j ∈ 𝒥} {\tilde{R}}_{j , oil {j}_{}} ] & ( 1 a ) \\ s . t . 𝔼 [ {\sum }_{j ∈ 𝒥} {\tilde{R}}_{j , water {j}_{}} ] \leq {U}_{water}^{max} & ( 1 b ) \\ {j}_{} ∈ [ 0 , 1 ] ∀ j ∈ 𝒥 & ( 1 c )\end{matrix}$$

which can be conveniently re-written as:

$$\begin{matrix}{max}_{y ∈ ℱ} 𝔼 {\sum }_{j ∈ 𝒥} {\vec{R}}_{j , oil {j}_{}} & ( 2 a ) \\ s . t . {\sum }_{j ∈ 𝒥} {\overline{R}}_{j , water {j}_{}} \leq {U}_{water}^{max} & ( 2 b ) \\ {j}_{} ∈ [ 0 , 1 ] ∀ j ∈ 𝒥 & ( 2 c )\end{matrix}$$

where [symbol] is the set of wells under consideration, [symbol] denotes a binary decision variable taking value 1 if well j is open; 0 otherwise (i.e., if well j is shut in), U_{water}^{max} is the water limit expressed as a rate [kbd], and [symbol] is a set of side constraints that may impose other restrictions on which wells can be open or shut in. The Stochastic Knapsack method formulates the problem as a stochastic knapsack problem with side constraints. Both the Deterministic Knapsack and the Stochastic Knapsack may be characterized as rigorous optimization solutions. As can be seen in FIG. 5B, the Fractional Knapsack strategy results in expected production of 18.50 kbd and 287.50 kbd of oil and water, respectively. Meanwhile, the Deterministic Knapsack strategy results in expected oil and water production of 19.60 kbd and 314.40 kbd, respectively, while the Stochastic Knapsack strategy results in expected oil and water production of 18.60 kbd and 314.40 kbd, respectively.

According to method 300, the well seriatum strategies illustrated in FIG. 5B may be generated at block 370. At block 380 of method 300, an operator may implement the Deterministic Knapsack strategy to maximize the oil production rate. For example, FIG. 5C illustrates implementation details of each strategy by placing a “1” in the row of each well that is to be kept open. Thus, at 583, the operator is instructed to shut in wells 3 and 5 under the Deterministic Knapsack strategy. Alternatively, the operator may implement the Stochastic Knapsack strategy (second-highest oil production rate) based on the operator's confidence in the rate estimates. For example, at 584, the operator is instructed to shut in wells 2 and 5 under the Stochastic Knapsack strategy. Note that the Deterministic Knapsack strategy nearly hits the water rate limit (see FIG. 5B) with a 0.52 probability of not violating the water handling constraint. In contrast, the Stochastic Knapsack approach predicts that the water handling constraint will be satisfied with very high probability (0.98).

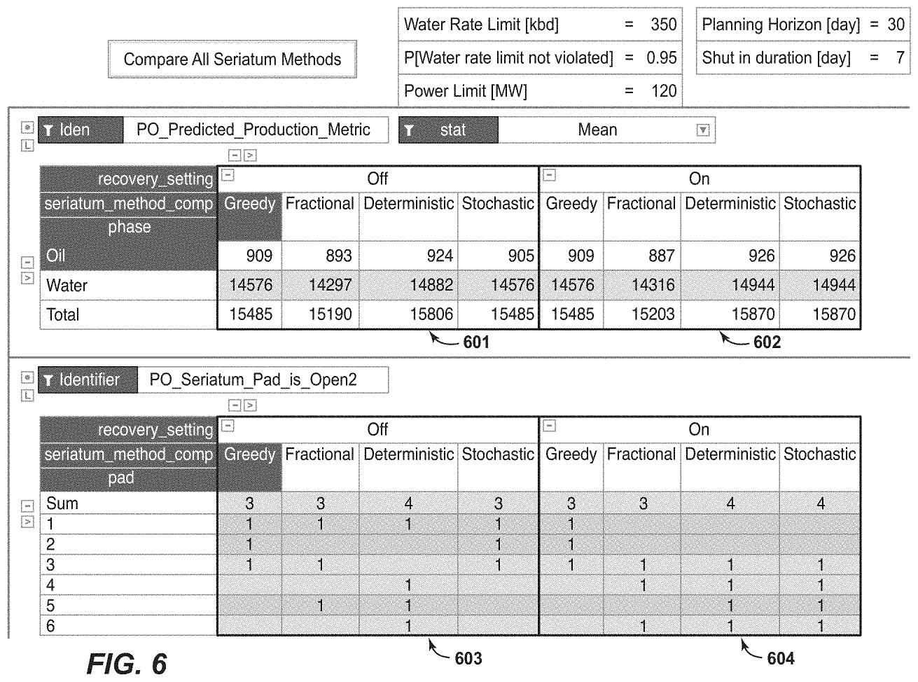

A second example implementation of method 300 is illustrated in FIG. 6. This second example extends the first example by considering, in addition to the imminent water-handling rate limit, future (post-shut in) oil production. As illustrated, this example presents a 30-day planning horizon, which includes an initial 7-day interval where the water-handling constraint of the first example is enforced (production is regulated in one or more wells). In FIG. 6, the wells are classified into two types: Wells 1, 2, and 5 have a high probability of achieving oil production rates after a production regulation event, while wells 3, 4, and 6 have a low probability of achieving oil production rates after a production regulation event. According to method 300, monitoring well seriatum at block 380 provides feedback information at block 330 that wells 3, 4, and 6 are prone to produce less after a production regulation event, resulting in the classification shown in FIG. 6.

Sections 601 and 602 of FIG. 6 show the expected oil, water, and total liquid production from all wells (pads) over the planning horizon. In Section 601, post shut-in oil recovery is not considered. In Section 602, post shut-in oil recovery is considered. Sections 603 and 604 of FIG. 6 list the wells that are open in each well seriatum strategy (“1” indicates the well is open, while a blank cell means that the well is shut in). In Section 603, post shut-in oil recovery is not considered. In Section 604, post shut-in oil recovery is considered.

It can be seen in FIG. 6 that, for each well seriatum strategy, considering post shut-in recovery (see Section 602) always yields higher expected oil production than the same strategy that does not consider post shut-in recovery (see Section 601). In particular, the Deterministic Knapsack strategy that does not account for future production (see Section 603), shuts in wells 2 and 3, even though well 3 is known to have lower expected oil production after being shut in. In contrast, the Deterministic Knapsack approach that does account for future production (see Section 604) keeps well 3 open to avoid this possible production decline.

FIG. 6 also shows that the two strategies based on rigorous optimization (e.g., Deterministic Knapsack and Stochastic Knapsack) significantly outperform the heuristic strategies that had been heretofore used in practice (e.g., Greedy and Fractional Knapsack).

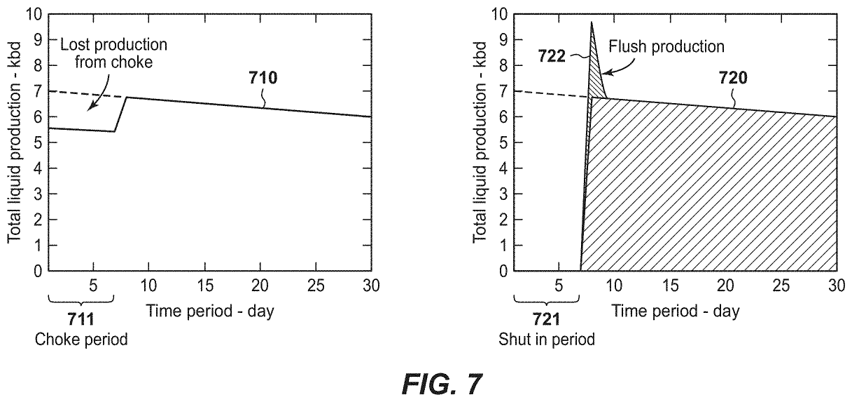

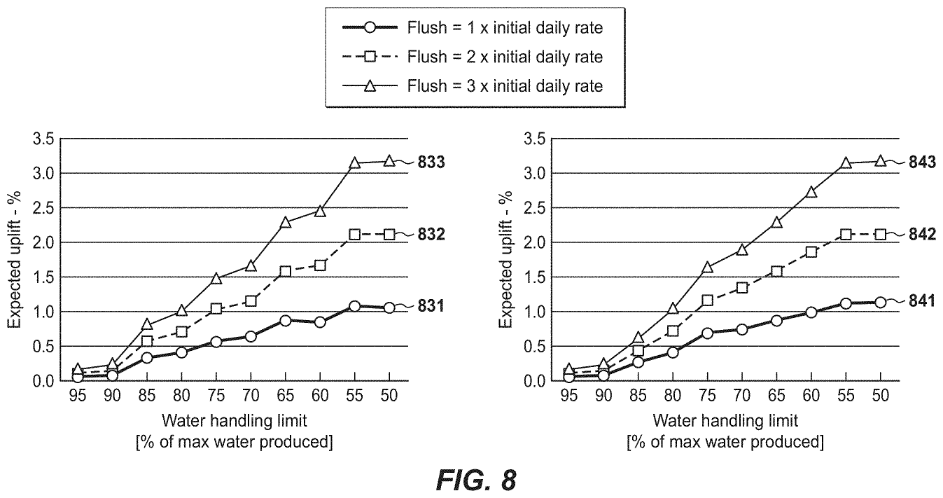

A third example of method 300 is illustrated in FIGS. 7 and 8. This third example extends from the second example. As in the second example, a 30-day planning horizon is considered with a 7-day production regulation event at the beginning of the planning horizon. Graph 710 of FIG. 7 illustrates liquid production during and following a well-choke production regulation event 711. Graph 720 of FIG. 7 illustrates liquid production during and following a well shut-in production regulation event 721. Note the flush production 722 that occurs once the well is re-opened following the shut-in event 721. In this example, it is assumed that choking a well has a linear effect on production, and that no flush production occurs following the choke event.

FIG. 8 illustrates expected uplift as a function of the water-handling limit for different flush production and production regulation event assumptions. The expected uplift is computed as the ratio

$$\frac{( {z}_{1} - {z}_{2} )}{{z}_{2}} ,$$

where z₁ is the expected total oil from production method 300, and z₂ is the expected total oil production from methods which do not consider post-shut-in production. Graph 831 illustrates expected uplift for flush production that is the same as the initial daily production rate, and production regulation events limited to shut in. Graph 832 illustrates expected uplift for flush production that is twice the initial daily production rate, and production regulation events limited to shut in. Graph 833 illustrates expected uplift for flush production that is three times the initial daily production rate, and production regulation events limited to shut in. Graph 841 illustrates expected uplift for flush production that is the same as the initial daily production rate, and production regulation events include shut in or choking to as little as 80% of the nominal rate. Graph 842 illustrates expected uplift for flush production that twice the initial daily production rate, and production regulation events include shut in or choking to as little as 80% of the nominal rate. Graph 843 illustrates expected uplift for flush production that three-times the initial daily production rate, and production regulation events include shut in or choking to as little as 80% of the nominal rate. Note that the graphs in FIG. 8 that allow for well choke production regulation have smoother, more gradual uplift curves than those that restrict production regulation to shut-in events.

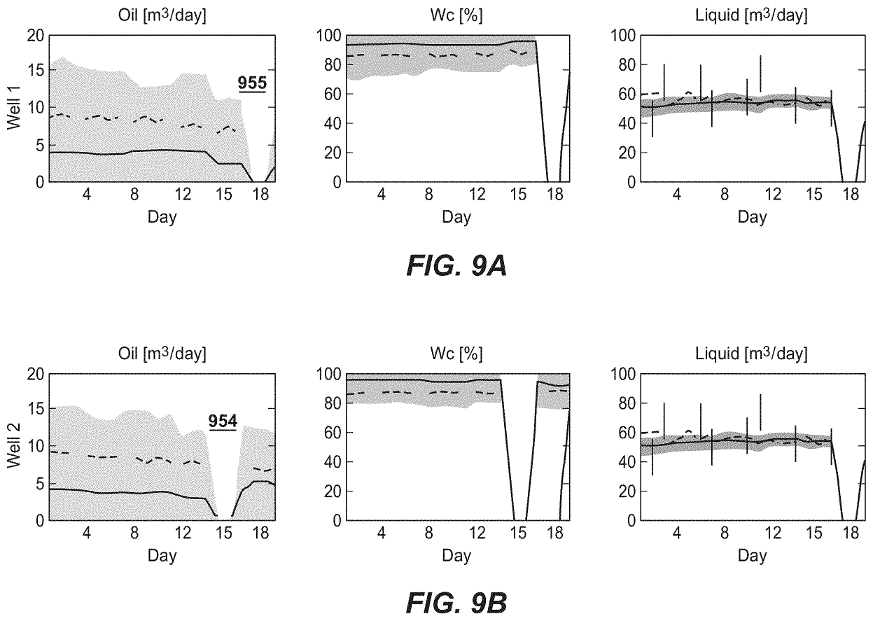

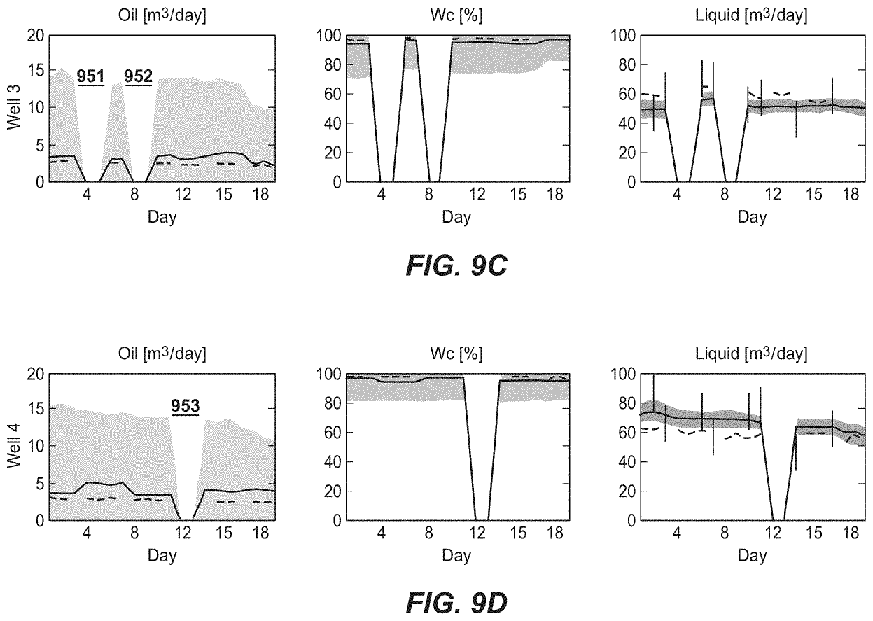

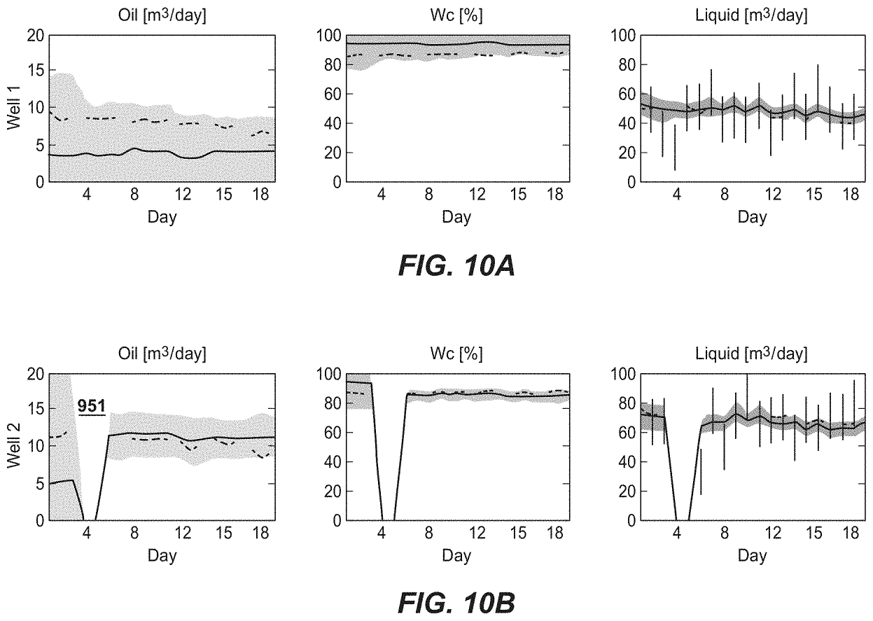

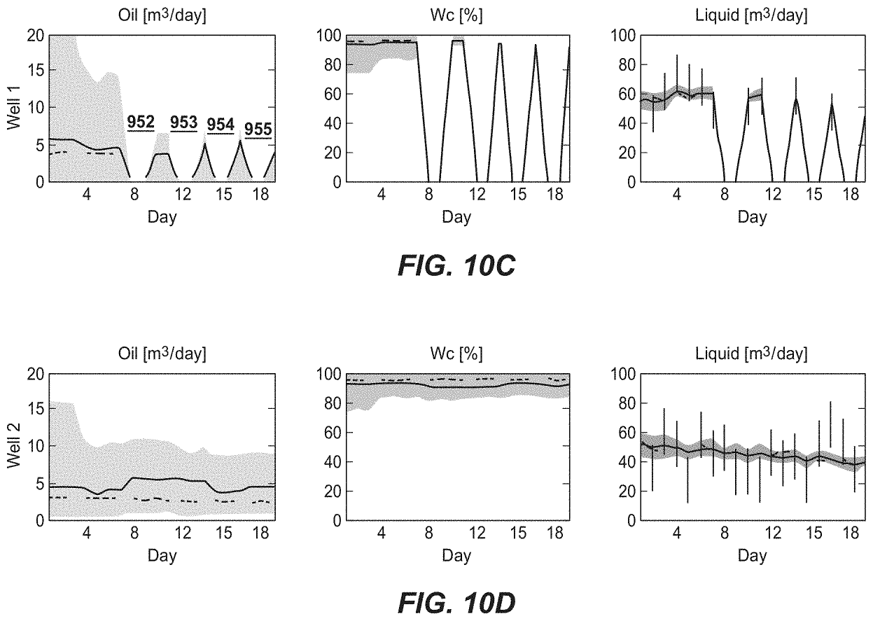

A fourth example of method 300 is illustrated in FIGS. 9A-D and 10A-D. This example illustrates the benefits of using shut-in information to improve production rate estimates and, as a consequence, make better decisions for future production regulation events. These improved decisions may ultimately lead to high field-wide oil production. In this example, a well group includes four wells, each with a total liquid rate of 60 kbd. Wells 1 (FIGS. 9A and 10A) and 2 (FIGS. 9B and 10B) are high oil-producing wells, having a water-cut of 0.85. Meanwhile, wells 3 (FIGS. 9C and 10C) and 4 (FIGS. 9D and 10D) are (relatively) low oil-producing wells, having a water-cut of 0.95. This example considers a 20-day planning horizon.

In FIGS. 9A-D and 10A-D (similar to FIGS. 2A-D), the oil production rates (over time) for each well are shown on the left graph of each figure. In FIGS. 9A-D and 10A-D, the water production rates are shown in the middle, while the total production rates are shown on the right. In each figure, the dotted lines show the actual production rates. The solid lines denote the estimated production rates. The shadings indicate the estimated probability bands (spanning 5% to 95% uncertainty).

As illustrated in FIGS. 9A-D and 10A-D, at the outset of the simulation, the estimated production rates and the estimated probability bands for each well appear identical, as no distinguishing information is available or assumed. In the illustrated 20-day planning horizon, there are five two-day production regulation events. Event 951 spans time interval days 4-5; event 952 spans time interval days 8-9; event 953 spans time interval days 12-13; event 954 spans time interval days 15-16; and event 955 spans time interval days 18-19. During each production regulation event, an identified objective (from block 350 of method 300) is to enforce a water-handling limit of 200 kbd. In this example, each production regulation event is complete shut in of only one well for the duration of the production regulation event. Shut-in decisions (from block 370) are made based on a solution of the sample average approximation model having a 0.95 probability of not violating the water-handling limit.

FIGS. 9A-D illustrate successive production regulation decisions made (at block 370) in the absence of updating well information (at block 310) with information gathered during monitoring the implementation of the well seriatum (at block 380). Production regulation event 951 involves a shut in of well 3 (FIG. 9C). Following event 951, the estimated production rates and the estimated probability bands of well 3 return to previous values. Again, production regulation event 952 involves another shut in of well 3 (FIG. 9C), and following event 952, the estimated production rates and the estimated probability bands of well 3 return to previous values. It can be seen that erratic shut-in decisions are made for events 953, 954, and 955. Note that events 954 and 955 result in high oil-producing wells 1 and 2 being shut in.

In contrast, FIGS. 10A-D illustrate successive production regulation decisions made (at block 370) with the benefit of updating well information (at block 310) with information gathered during monitoring the implementation of the well seriatum (at block 380). Production regulation event 951 involves a shut in of well 2 (FIG. 9B). Following event 951, the estimated production rates and the estimated probability bands of well 2 are set to more accurate values based on the updated information. Likewise, production regulation event 952 involves a shut in of well 3 (FIG. 9C), and following event 952, the estimated production rates and the estimated probability bands of well 3 are set to more accurate values. Note that, after shutting in high oil-producing well 2 during the event 951, a low oil-producing well 3 is shut in during all subsequent production regulation events 953-955.

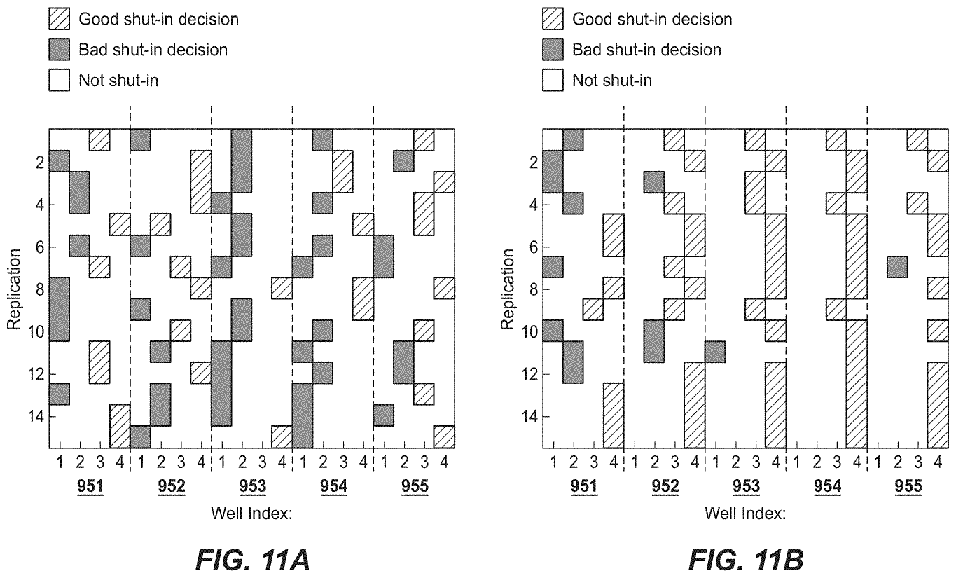

The following two examples demonstrate the feasibility and advantages of method 300. The fifth example, as illustrated in FIGS. 11A-B, extends from the fourth example. Note that the fourth example, illustrated in FIGS. 9A-D and 10A-D, shows rate estimates and shut-in decisions for a single simulation (i.e., one sample path of data over a twenty-day planning horizon). The fifth example presents fifteen replications (e.g., by Monte Carlo simulation) of a comparison of shut-in decisions with (FIG. 11B) and without (FIG. 11A) updates from monitoring over the five sequential production regulation events 951-955. As in the fourth example, wells 1 and 2 are assumed to be high oil producers, while wells 3 and 4 are assumed to be low oil producers. In each of FIGS. 11A-B, for each production regulation event 951-955, one or more wells are shut in. Monitoring the implementations (e.g., as in block 380) results in an assessment whether the shut-in decision was good or bad. (As illustrated, good decisions are those where low oil-producing wells are shut in, while bad decisions are those where high oil-producing wells are shut in.)

In FIG. 11B, during production regulation events 953-955, only two high oil-producing wells are shut in (i.e., well 1 during the 11^{th} replication of production regulation event 953, and well 2 during the 7^{th} replication of production regulation event 955). Whereas, in FIG. 11A, high oil-producing wells are shut in during nearly half of replications during events 953-955. Heretofore, many high oil-producing wells have been shut in when shut-in information is not used to updated production rate estimates. Low oil-producing wells may be shut in with a much higher probability when rate estimates are updated with shut-in monitoring information (e.g., feedback loop from block 380 to block 310).

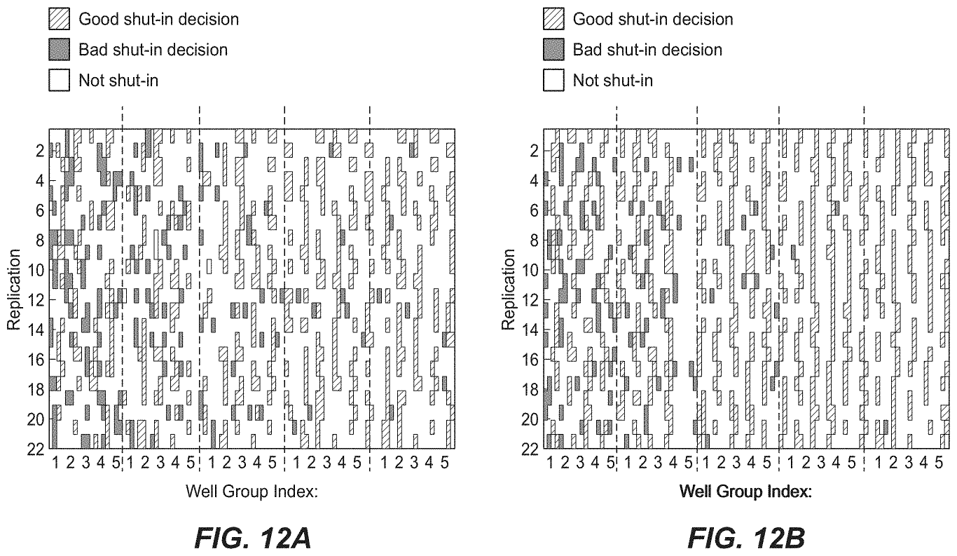

A sixth example of method 300 is illustrated in FIGS. 12A-B. This sixth example extends from the prior examples. In the prior examples, only a single objective is identified (see block 350). In this sixth example, the objective of achieving high short-term oil-production levels is balanced with an objective of diversification of well groups subject to production regulation events. This example demonstrates how well grouping diversification can be applied as a secondary objective to improve field-wide oil production. The sixth example presents twenty-two replications (e.g., by Monte Carlo simulation) of a comparison of shut-in decisions with (FIG. 12B) and without (FIG. 12A) updates from monitoring over the five sequential production regulation events 951-955.

The well seriatum optimization examples described in the previous examples do not include well group information when determining a well seriatum. For example, wells may be grouped by lateral location, date first drilled, date first produced, maximum depth, geologic significance of surrounding subsurface region, etc. Well groupings may be a proxy for reservoir participation and/or communication. Well groupings may be identified, for example, as part of the well information at block 330. In FIGS. 12A-B, each column identified by a well group index number contains four different good/bad decision indicators, one for each well in that group. As in FIGS. 12A-B, monitoring the implementations (block 380) results in an assessment whether the shut-in decisions are good or bad. (As illustrated, good decisions are those where low oil-producing wells are shut in, while bad decisions are those where high oil-producing wells are shut in.)

FIG. 12A-B illustrate that, at times, it may be more beneficial (in terms of total field-wide production over a planning horizon of several weeks or months) to regulate a small number of wells from multiple different well groups (rather than most or all from one group). Similar to the improvements shown in FIGS. 11A-B, FIGS. 12A-B illustrate that considering well group diversification leads to fewer high oil-producers being shut in during production regulation events 953-955. In some embodiments, identifying objectives in block 350 may include setting a target amount of expected oil production to be sacrificed in the short term in order to achieve diversification. By diversifying well shut-in decisions amongst well groups, individual well production rates may be improved, which in turn can lead to increased oil production in the long-run.

In practical applications, the present technological advancement may be used in conjunction with a production data analysis system (e.g., a high-speed computer) programmed in accordance with the disclosures herein. Preferably, the production data analysis system is a high performance computer (HPC), as known to those skilled in the art. Such high performance computers typically involve clusters of nodes, each node having multiple CPUs and computer memory that allow parallel computation. The models may be visualized and edited using any interactive visualization programs and associated hardware, such as monitors and projectors. The architecture of the system may vary and may be composed of any number of suitable hardware structures capable of executing logical operations and displaying the output according to the present technological advancement. Those of ordinary skill in the art are aware of suitable supercomputers available from Cray or IBM.

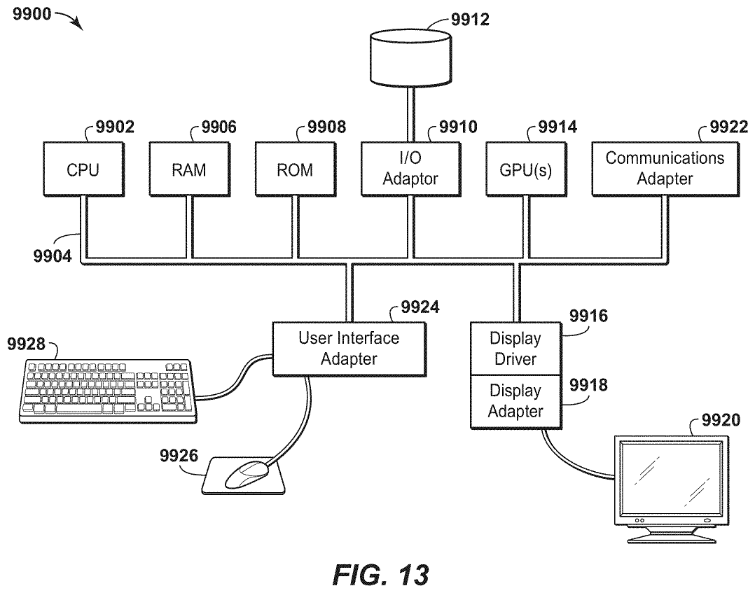

FIG. 13 illustrates a block diagram of a production data analysis system 9900 upon which the present technological advancement may be embodied. A central processing unit (CPU) 9902 is coupled to system bus 9904. The CPU 9902 may be any general-purpose CPU, although other types of architectures of CPU 9902 (or other components of exemplary system 9900) may be used as long as CPU 9902 (and other components of system 9900) supports the operations as described herein. Those of ordinary skill in the art will appreciate that, while only a single CPU 9902 is shown in FIG. 13, additional CPUs may be present. Moreover, the system 9900 may comprise a networked, multi-processor computer system that may include a hybrid parallel CPU/GPU system. The CPU 9902 may execute the various logical instructions according to various teachings disclosed herein. For example, the CPU 9902 may execute machine-level instructions for performing processing according to the operational flow described.

The production data analysis system 9900 may also include computer components such as non-transitory, computer-readable media. Examples of computer-readable media include a random access memory (RAM) 9906, which may be SRAM, DRAM, SDRAM, or the like. The system 9900 may also include additional non-transitory, computer-readable media such as a read-only memory (ROM) 9908, which may be PROM, EPROM, EEPROM, or the like. RAM 9906 and ROM 9908 hold user and system data and programs, as is known in the art. The system 9900 may also include an input/output (I/O) adapter 9910, a communications adapter 9922, a user interface adapter 9924, and a display adapter 9918; the system 9900 may potentially also include one or more graphics processor units (GPUs) 9914, and one or more display drivers 9916.

The I/O adapter 9910 may connect additional non-transitory, computer-readable media such as storage device(s) 9912, including, for example, a hard drive, a compact disc (CD) drive, a floppy disk drive, a tape drive, and the like to production data analysis system 9900. The storage device(s) may be used when RAM 9906 is insufficient for the memory requirements associated with storing data for operations of the present techniques. The data storage of the system 9900 may be used for storing information and/or other data used or generated as disclosed herein. For example, storage device(s) 9912 may be used to store configuration information or additional plug-ins in accordance with the present techniques. Further, user interface adapter 9924 couples user input devices, such as a keyboard 9928, a pointing device 9926 and/or output devices to the system 9900. The display adapter 9918 is driven by the CPU 9902 to control the display on a display device 9920 to, for example, present information to the user. For instance, the display device may be configured to display visual or graphical representations of any or all of the information, models, and/or decision support tools discussed herein (e.g., well seriatum). As the models themselves are representations of geophysical data, such a display device may also be said more generically to be configured to display graphical representations of a geophysical data set, which geophysical data set may include the information, models, and/or decision support tools discussed herein (e.g., well seriatum), as well as any other geophysical data set those skilled in the art will recognize and appreciate with the benefit of this disclosure.

The architecture of production data analysis system 9900 may be varied as desired. For example, any suitable processor-based device may be used, including without limitation personal computers, laptop computers, computer workstations, and multi-processor servers. Moreover, the present technological advancement may be implemented on application specific integrated circuits (ASICs) or very large scale integrated (VLSI) circuits. In fact, persons of ordinary skill in the art may use any number of suitable hardware structures capable of executing logical operations according to the present technological advancement. The term “processing circuit” encompasses a hardware processor (such as those found in the hardware devices noted above), ASICs, and VLSI circuits. Input data to the system 9900 may include various plug-ins and library files. Input data may additionally include configuration information.

The above-described techniques, and/or systems implementing such techniques, can further include hydrocarbon management based at least in part upon the above techniques. For instance, methods according to various embodiments may include managing hydrocarbons based at least in part upon well seriatum generated and/or implemented according to the above-described methods.

The foregoing description is directed to particular example embodiments of the present technological advancement. It will be apparent, however, to one skilled in the art, that many modifications and variations to the embodiments described herein are possible. All such modifications and variations are intended to be within the scope of the present disclosure, as defined in the appended claims.

1. A method of production surveillance and management, comprising:
obtaining input for a plurality of wells in a field, wherein the input comprises well information collected for at least one of the wells in the field;
generating a well seriatum for the plurality of wells based on the input;
updating the well information based on a monitoring of an implementation of the well seriatum; and
updating the well seriatum based on the updated well information.

2. The method of claim 1, further comprising:
causing the well seriatum to be implemented, wherein the implementation includes some of a plurality of actions identified in the well seriatum; and
causing the implementation to be monitored.

3. The method of claim 1, wherein the input further comprises:
updated status records; and
identified objectives.

4. The method of claim 3, wherein the updated status records comprise a resource limit.

5. The method of claim 3, wherein the identified objectives comprise at least one of: maximizing oil production, maximizing gas production, minimizing water production, minimizing power consumption, minimize oil loss, maximize oil uplift, maximizing knowledge about field performance, maximizing well group diversification, and a user-set criterion.

6. The method of claim 3, wherein:
the well information comprises well grouping information; and
the identified objectives comprise group diversification for production regulation events.

7. The method of claim 1, further comprising:
creating a forecast based on the input, wherein generating the well seriatum is based on the forecast;
creating an updated forecast based on the updated well information, wherein:
the forecast comprises a probability estimate,
the updated forecast comprises an updated probability estimate, and
the updated probability estimate is more accurate than the probability estimate;
wherein the probability estimate comprises a water-cut estimate.

8. The method of claim 1, wherein the well seriatum comprises a listing of production regulation events for the plurality of wells, the production regulation events being time-based and comprising at least one of: a well shut in, and a well choke.

9. The method of claim 1, wherein the updated well information comprises flush production estimates.

10. The method of claim 1, wherein the well information comprises an aggregate measurement for the plurality of wells.

11. A method of production surveillance and management, comprising, for a plurality of iterations:
obtaining input for a plurality of wells in a field, wherein the input comprises well information collected for at least one of the wells in the field;
creating a forecast based on the input;
generating a well seriatum for the plurality of wells based on the input and the forecast; and
monitoring an implementation of the well seriatum to obtain the input for the plurality of wells for a subsequent iteration.

12. The method of claim 11, wherein the input further comprises:
updated status records comprising a resource limit; and
identified objectives comprising at least one of: maximizing oil production, maximizing gas production, minimizing water production, minimizing power consumption, minimize oil loss, maximize oil uplift, maximizing knowledge about field performance, maximizing well group diversification, and a user-set criterion.

13. The method of claim 12, wherein:
the well information comprises well grouping information; and
the identified objectives comprise group diversification for production regulation events.

14. The method of claim 11, wherein, for each iteration:
the forecast comprises a probability estimate, said probability estimate comprising a water-cut estimate, and
the probability estimate is more accurate than that for a preceding iteration.

15. The method of claim 14, wherein, for at least one iteration:
the implementation of the preceding iteration comprises a production regulation event for a first well, and
the more accurate probability estimate comprises a probability estimate for a second well.

16. The method of claim 11, wherein the well seriatum comprises a listing of time-based production regulation events for the plurality of wells, the production regulation events comprising at least one of: a well shut in, and a well choke.

17. The method of claim 11, wherein the input comprises flush production estimates.

18. The method of claim 11, wherein the well information comprises an aggregate measurement for the plurality of wells.

19. The method of claim 11, wherein each iteration follows an immediately-preceding iteration by a selected time interval, wherein the selected time interval is no more than 3 days.

20. A method of hydrocarbon management comprising:
obtaining input for a plurality of wells in a field, wherein the input comprises well information collected for at least one of the wells in the field;
generating a well seriatum for the plurality of wells based on the input;
causing the well seriatum to be implemented, wherein the implementation includes some of a plurality of actions identified in the well seriatum;
causing the implementation to be monitored;
updating the well information based on the monitoring of the implementation; and
updating the well seriatum based on the updated well information.
